(19) United States
(12) Patent Application Publication
(10) Pub. No.: US 2024/0400869 A1
(43) Pub. Date: Dec. 5, 2024

(54) HOT MELT SEALANTS HAVING LOW THERMAL CONDUCTIVITY

(71) Applicant: H.B. Fuller Company, St. Paul, MN (US)

(72) Inventors: Harald Becker, Stelzenberg (DE); Brian R. White, New Brighton, MN (US); Heike S. Bruecher, Rathsweiler (DE); Oliver Kron, Kirkel-Limbach (DE); Dirk Raatz, Landau i. d. Pfalz (DE)

(21) Appl. No.: 18/677,470

(22) Filed: May 29, 2024

Related U.S. Application Data
(60) Provisional application No. 63/505,150, filed on May 31, 2023.

(51) Int. Cl. C09J 123/20; B32B 7/12; B32B 17/10; C09J 5/06; C09J 11/04

(52) U.S. Cl. CPC C09J 123/20; B32B 7/12; B32B 17/10036; B32B 17/10614; C09J 5/06; C09J 11/04; B32B 2255/26; B32B 2264/102; B32B 2264/108; B32B 2307/724; B32B 2419/00; B32B 2457/12

(57) ABSTRACT

The invention includes hot melt sealants having a low thermal conductivity in which the polymer component is maximized, and specialized fillers are not needed. The inventive sealants have found utility as thermoplastic spacers, edge seals and single seals.

### CROSS REFERENCE TO RELATED APPLICATIONS

This application claims the benefit of U.S. Provisional Application No. 63/505,150, filed May 31, 2023, and incorporated herein.

### BACKGROUND

Many insulating glass windows are formed by two panes of glass on either side of a mechanical spacer, that is often metal. The mechanical spacer holds the two panes a fixed distance apart and includes a desiccant within the mechanical spacer to keep the sealed space between the panes dry. A primary sealant is used to form a seal between the sides of the spacer that faced the glass pane and the inner surface of the glass pane. The primary sealant serves to hold the unit together and to help form a water vapor and gas barrier. A secondary sealant is then applied over the primary sealant on the outside edge of the unit to form an additional seal and provide strength to the assembly.

It an alternate way of forming an insulating glass window, the mechanical spacer and primary sealant can be replaced with a single sealant including desiccant that fulfills the functions of both (i.e., thermoplastic spacer). A secondary sealant as described above is still often used. Removing the metal spacer, improves the efficiency of the insulating glass window by lowering thermal conductivity of the edge seal (since a metal spacer is no longer present). However, the absence of the metal spacer also puts an increased burden on the sealant used as a thermoplastic spacer.

There is a need to further lower the thermal conductivity of hot melt sealants used as thermoplastic spacers and edge seals and to improve the efficiency of the window while maintaining the adhesive, strength, and elastic properties required of a thermoplastic spacer.

### SUMMARY

In one aspect, the invention features a hot melt sealant including from 1% by weight to 30% by weight of a silane modified polymer, from 30% by weight to 65% by weight of a butene component, from 10% by weight to 34% by weight of carbon black, from 2% by weight to 20% by weight of a desiccant, wherein the hot melt sealant has a total polymer content of greater than 55% by weight.

In another aspect, the invention features a hot melt sealant including from 2% by weight to 18% by weight of a silane modified polymer, from 35% by weight to 60% by weight of a butene component, from 15% by weight to 32% by weight of carbon black, from 3% by weight to 18% of a desiccant, wherein the hot melt sealant has a total polymer content of greater than 55% by weight.

In a different aspect, the invention features a hot melt sealant including from 3% by weight to 15% by weight of a silane modified olefin, from 40% by weight to 60% by weight of a butene component, from 18% by weight to 30% by weight of a carbon black, from 5% by weight to 15% by weight of a desiccant, wherein the hot melt sealant has a total polymer content of greater than 58% by weight and the carbon black makes up at least 75% by weight of the non-desiccant filler in the hot melt sealant.

In one embodiment, the invention features a thermoplastic spacer including the hot melt sealant. In another embodiment, the invention features an edge seal for a module selected from the group consisting of solar thermal module and photovoltaic module.

In one embodiment, the hot melt sealant includes a total polymer content of greater than 58% by weight. In another embodiment, the hot melt sealant has a density of no greater than 1.20 g/cm³, or even no greater than 1.18 g/cm³ when tested according to EN ISO 2811-1, or even a density of from 0.95 g/cm3 to 1.20 g/cm³ when tested according to EN ISO 2811-1.

The hot melt sealant can have a thermal conductivity of no greater than 0.330, Watts/m-K or even no greater than 0.320 Watts/m-K when tested according to ASTM D5470.

In another embodiment, the hot melt sealant includes from 22% by weight to 32% by weight of the carbon black. In one embodiment, the carbon black makes up at least 70% by weight of the non-desiccant filler in the hot melt sealant.

In a different embodiment, the butene component is selected from the group consisting of polybutene, polyisobutene, polyisobutylene, butyl rubber and combination thereof. In another embodiment, the hot melt sealant includes a medium molecular weight (Mₙ) butene component and a high molecular weight (Mₙ) butene component. In one embodiment, the butene component includes at least two different butene components having different molecular weights (Mₙ).

In one embodiment, the hot melt sealant includes a silane adhesion promoter. In another embodiment, the silane modified polymer is a silane modified olefin that has a silicon content as tested by KAA 04-3080 of from 0.2% to 5% by weight. In one embodiment, the silane modified polymer is a silane modified olefin selected from the group consisting of a silane modified amorphous poly alpha olefin, a silane modified single-site catalyzed olefin, and combinations thereof. In a different embodiment, the silane modified polymer is a silane modified amorphous poly alpha olefin. In another embodiment, the silane modified polymer is a silane modified single-site catalyzed poly alpha olefin.

In one embodiment, the hot melt sealant further includes a dispersing agent.

In a different embodiment, the invention features an insulating glass unit including a first pane of glass, a second pane of glass, and the hot melt sealant in contact with the first pane of glass and the second pane of glass. In a different embodiment, the insulating glass unit is free of a mechanical spacer.

The inventors have discovered hot melt sealants that can be used as a thermoplastic spacer, a single seal, or an edge seal and have a decreased thermal conductivity. These hot melt sealants can be used for insulating glass windows, solar thermal modules and as an edge seal for photovoltaic modules. Further, the use of specialized fillers such as e.g., hollow microspheres is not required.

Other features and advantages will be apparent from the following description of the preferred embodiments and from the claims.

### DETAILED DESCRIPTION

### Hot Melt Sealant

In one aspect, the invention features a hot melt sealant including from 1% by weight to 30% by weight of a silane modified polymer, from 30% by weight to 65% by weight of a butene component, from 10% by weight to 34% by weight of carbon black, and from 2% by weight to 20% by weight of a desiccant, wherein the hot melt sealant has a total polymer component content of greater than 55% by weight.

In one aspect, the invention features a hot melt sealant including from 2% by weight to 18% by weight of a silane modified polymer, from 35% by weight to 60% by weight of a butene component, from 15% by weight to 32% by weight of carbon black, and from 3% by weight to 18% by weight of a desiccant, wherein the hot melt sealant has a total polymer component content of greater than 55% by weight.

In one aspect, the invention features a hot melt sealant including from 3% by weight to 15% by weight of a silane modified olefin, from 40% by weight to 60% by weight of a butene component, from 18% by weight to 30% by weight of carbon black, and from 5% by weight to 15% by weight of a desiccant, wherein the hot melt sealant has a total polymer component content of greater than 58% by weight and the carbon black makes up at least 75% by weight of the non-desiccant filler in the hot melt sealant.

In another aspect, the invention features a hot melt sealant including from 3% by weight to 15% by weight of a silane modified olefin, from 40% by weight to 60% by weight of a butene component, from 18% by weight to 30% by weight of carbon black, and from 5% by weight to 15% by weight of a desiccant, wherein the hot melt sealant has a total polymer component content of greater than 58% by weight and a density of from 1.10 g/cm³ to 1.20 g/cm³ from when tested according to EN ISO 2811-1.

In another aspect, the invention features a hot melt sealant including from 3% by weight to 15% by weight of a silane modified olefin, from 40% by weight to 60% by weight of a butene component including at least one high molecular weight butene component, from 18% by weight to 30% by weight of a carbon black having a BET surface area according to ASTM D6556 of from 95 m²/g to 150 m²/g, and from 5% by weight to 15% by weight of a desiccant, wherein the hot melt sealant has a total polymer component content of greater than 58% by weight.

The silane modified polymer (e.g., silane modified olefin), the butene component, the carbon black and the desiccant can make up at least 60% by weight, at least 65% by weight, at least 70% by weight, at least 75% by weight, at least 80% by weight, at least 85% by weight, at least 90% by weight, at least 95% by weight, from 60% by weight to 100% by weight, from 70% by weight to 100% by weight, from 75% by weight to 100% by weight, from 80% by weight to 100% by weight, from 85% by weight to 100% by weight, or even from 90% by weight to 100% by weight of the hot melt sealant.

In the hot melt sealants of this invention the functional group (e.g., silane) on the silane modified polymer crosslinks upon contact with water. Crosslinking can occur within the modified polymer, with the glass of the windowpanes and with silicones (when they are used as a secondary sealant). This crosslinking strengthens the window unit.

The hot melt sealants of this invention can serve as a thermoplastic spacer between panes of an insulating glass window, panes of a solar thermal module and as an edge seal for a photovoltaic module.

The hot melt sealants of this invention have improved wet out speed as tested by the Glass Wet Out Speed test. As such, they can also be used as a single seal. As used herein the term “single seal” means that there is no secondary sealant present in the insulating glass window, the solar thermal module, or the photovoltaic module.

Alternatively, the insulating glass window, solar thermal module, or photovoltaic module can include a secondary sealant. The secondary sealant is applied over the top of the thermoplastic spacer along the outer edge of the unit, to further strengthen the assembly. The type of secondary sealant is not particularly limited. The secondary sealant can be selected from the group consisting of a one-part sealant and a two-part sealant. The secondary sealant can be selected from the group consisting of room temperature liquid sealants (e.g., polysulfides, polyurethanes, silicones, etc.), reactive hot melt sealants (e.g., polyurethanes, silane modified hot melts, etc.) and non-reactive hot melt sealants (e.g., butyl sealants).

In the hot melt sealants of this invention, the polymer content is maximized (and the filler content is minimized). Maximizing the polymer content of the hot melt sealant, lowers its density. The hot melt sealants of this invention have a lower density as compared to prior art hot melt sealants used as a thermoplastic spacer. Thermal conductivity is related to density; as density decreases, the surface contact between particles decreases, causing the thermal conductivity to decrease.

Maximizing the polymer content in a hot melt sealant, especially one used as a thermoplastic sealant or a single seal, is not a trivial matter. The fillers used in hot melt sealants contribute to many of the properties needed for performance e.g., strength, rheological properties, etc. The hot melt sealant compositions of this invention achieve lower thermal conductivity, while maintaining other critical properties, without the need for specialized fillers such as e.g., hollow microspheres.

The hot melt sealant has a density of no greater than 1.25 g/cm³, no greater than 1.23 g/cm³, no greater than 1.21 g/cm³, no greater than 1.20 g/cm³, no greater than 1.19 g/cm³, no greater than 1.17 g/cm³, from 1.0 g/cm³ to 1.25 g/cm³, from 1.0 g/cm³ to 1.20 g/cm³, or even from 1.0 g/cm³ to 1.17 g/cm³ from when tested according to EN ISO 2811-1.

### Polymer Component

In the hot melt sealants of this invention the amount of the polymer component is maximized, to allow for lower thermal conductivity. The polymer component includes the total amount of polymeric materials in the hot melt sealant. The polymer component includes the total amount of the silane modified olefin, the butene component, the polymeric dispersing agent, and any other polymeric components (e.g., silane adhesion promoter, tackifying agent, styrene block copolymers, additional polymers (e.g., other olefin polymers, etc.)).

The polymer component does not include fillers, desiccants, antioxidants, pigments, etc.

The hot melt sealant includes a polymer content of greater than 51% by weight, greater than 52% by weight, greater than 53% by weight, greater than 54% by weight, greater than 55% by weight, greater than 56% by weight, greater than 57% by weight, greater than 58% by weight, from 51% by weight to 70% by weight, from 53% by weight to 70% by weight, from 55% by weight to 70% by weight, from 56% by weight to 70% by weight, or even from 58% by weight to 68% by weight.

### Silane Modified Polymer

The hot melt sealant composition includes a silane modified polymer. The silane modified polymer can be a silane modified olefin selected from the group consisting of silane modified amorphous poly alpha olefin (APAO), silane modified single-site catalyzed olefin, and combinations thereof.

Useful silane modified olefins are either completely amorphous or are semi-crystalline. In one embodiment, the enthalpy of fusion as tested by Differential Scanning Calorimeter (DSC) is no greater than 40 joules/gram, or even no greater than 20 joules/gram.

The silane modified olefin can have a melt viscosity at 190° C. as tested using a rotational viscosity according to DIN 53 019 of no greater than 20,000 mPa s, no greater than 15,000 mPa s, no greater than 10,000 mPa, from 25 mPa s to 20,000 mPa s, or even from 100 mPa s to 10,000 mPa s.

The silane modified olefin can have a Ring and Ball Softening Point as tested according to DIN EN 1427 of from 70° C. to 140° C., from 70° C. to 120° C., or even from 75° C. to 110° C.

The hot melt sealant according to the invention can comprise at least one silane modified α-olefin. The term “α-olefin” designates an alkene of formula CnH2n (n corresponding to the number of carbon atoms), which has a carbon-carbon double bond at the first carbon atom (α-carbon). Examples of α-olefins include ethylene, propylene, 1-butene, 2-methyl-1-propene (isobutylene), 1-pentene, 1-hexene, 1-heptene and 1-octene. The term “poly-α-olefin” designates homopolymers and copolymers obtained by polymerization or oligomerization of one or more α-olefins.

The α-olefin can be selected from the group consisting of propylene based olefins and ethylene based olefins.

According to a preferred embodiment, the silane modified olefin (A) comprises at least one, preferably at least two, alkoxy silyl groups of formula (I):

—Si(R1)p(OR2)3−p (I)

in which:
R1 represents a linear or branched alkyl radical comprising from 1 to 4 carbon atoms, with the possibility that when there are several radicals R1, these radicals are identical or different; R2 represents a linear or branched alkyl radical comprising from 1 to 4 carbon atoms, with the possibility that when there are several radicals R2, these radicals are identical or different, with the possibility that two groups OR2 may be engaged in the same ring; p is an integer equal to 0, 1 or 2, preferably equal to 0 or 1.

Such alkoxy silyl groups containing poly-α-olefins are known to a person skilled in the art and they can be produced, for example, by grafting unsaturated silanes, such as vinyltrimethoxysilane, into poly-α-olefins which have been obtained by Ziegler-Natta catalyzed polymerization or by single-site (e.g., metallocene catalyzed) polymerization.

Suitable alkoxy silyl group modified olefins include silane grafted homopolymers, copolymers, and terpolymers of monomers selected from the group consisting of ethylene, propylene, 1-butene and higher α-olefins. Particularly suitable alkoxy silyl groups containing poly-α-olefins include silane grafted homopolymers of propylene, silane grafted copolymers of propylene and ethylene, silane grafted copolymers of propylene and 1-butene or other higher α-olefins, and silane grafted terpolymers of ethylene, propylene, and 1-butene. Preferably, the at least one alkoxysilyl group containing poly-α-olefin is a silane grafted atactic poly-α-olefin, in particular a silane grafted amorphous poly-α-olefin (APAO).

The silane modified olefin can have a silicon content as tested by KAA 04-3080 of from 0.2% to 5% by weight, from 0.3% by weight to 4% by weight, or even from 0.3% by weight to 3% by weight.

Preferred silane modified olefins include silane modified amorphous poly-α-olefins that are commercially available under the VESTOPLAST trade designation from Evonik Operations GmbH (Marl, Germany) including, e.g., VESTOPLAST 206, a silane modified amorphous poly-α-olefins

The silane modified olefin is present in the hot melt sealant at from 1% by weight, 2% by weight, 2.5% by weight, 3% by weight to 12% by weight, 15% by weight, 18% by weight, 20% by weight, 23% by weight, 26% by weight, 30% by weight or any two values there between.

### Butene Component

The butene component includes polymers derived from butene.

The butene component can be selected from the group consisting of polybutene, polyisobutene, polyisobutylene, butyl rubber and combination thereof. The butene component can include more than one butene component. It can be useful to include a blend of butene components having differing number average molecular weights (Mₙ).

The butene component can be selected from the group consisting of low molecular weight, medium molecular weight, high molecular weight, and combinations thereof.

The low molecular weight butene component has a number average molecular weight (Mₙ) by Gel Permeation Chromatography of less than 7,000 grams/mole.

The medium molecular weight butene component has a number average molecular weight (Mₙ) by Gel Permeation Chromatography of from greater than 7,000 grams/mole to 40,000 grams/mole.

The high molecular weight butene component has a number average molecular weight (Mₙ) by Gel Permeation Chromatography of greater than 40,000 grams/mole.

The butene component can include at least one high molecular weight butene component.

The butene component can include a blend of butene components. The butene component can include three different butene components, for example a low molecular weight, a medium molecular weight, and a high molecular weight grade. The butene component can include two different butene components, for example a medium molecular weight and high molecular weight grade. The butene component can include any combination of low molecular weight, medium molecular weight, and high molecular weight butene components.

Useful butene components are commercially available under a variety of trade designations including, e.g., under the OPPANOL series of trade designations from BASF Corporation (Florham, New Jersey) including, e.g., OPPANOL B 10 SFN, OPPANOL B 12 SFN, OPPANOL B 15 SFN, and OPPANOL N 50 SF, the PB grades from Daelim Co. Ltd. (Seoul, Korea) including PB2000 and PB2400, the INDOPOL grades from Ineos Capital Limited (London, England) including INDOPOL H 100 to INDOPOL H 18 000, the BUTYL grades from ExxonMobil Chemical (Houston, Texas) including BUTYL 268 and BUTYL 065 and the X BUTYL grades from Arlanxeo Performance Elastomers (The Netherlands) including X BUTYL RB 100 and X BUTYL RB 301.

The butene component is present in the hot melt sealant at from 30% by weight, 35% by weight, 37% by weight, 40% by weight, 42% by weight, 45% by weight to 58% by weight, 60% by weight, 65% by weight, or any two values there between.

### Carbon Black

The hot melt sealant includes carbon black. Carbon black is a fine carbon powder used as a pigment and reinforcing filler that is made by burning hydrocarbons in insufficient air. The inventors have found carbon black to work particularly well for this hot melt sealant. Carbon black can make up at least 50% by weight, at least 55% by weight, at least 60% by weight, at least 65% by weight, at least 70% by weight, at least 75% by weight, at least 80% by weight, at least 90% by weight, from 50% by weight to 100% by weight, from 60% by weight to 100% by weight, from 70% by weight to 100% by weight, from 80% by weight to 100% by weight, from 90% by weight to 100% by weight, or even 100% by weight of the amount of the non-desiccant filler in the hot melt sealant.

The carbon black can have a primary particle size of between 15 and 65 nanometer. The carbon black can have a BET surface area according to ASTM D6556 of from 45 m²/g to 450 m²/g, from 65 m²/g to 300 m²/g, from 75 m²/g to 200 m²/g, or even from 95 m²/g to 150 m²/g. The carbon black can have an Oil Absorption Number of compressed sample according to ASTM D3493 of from 45 cm³/100 g to 450 cm³/100 g, from 75 cm³/100 g to 200 cm³/100 g, or even from 85 cm³/100 g to 125 cm³/100 g.

The carbon black is present in the hot melt sealant at from 10% by weight, 13% by weight, 15% by weight, 18% by weight, 20% by weight, 22% by weight, 23% by weight, 25% by weight to 30% by weight, 32% by weight, 34% by weight or any two values there between.

### Desiccant

The desiccant (or drying agent) is a water binding filler. The desiccant functions to help keep the interior of the unit (e.g., insulating glass unit, solar thermal module, or photovoltaic module) dry. The desiccant is not particularly limited and can be a chemical or physical drying agent. The desiccant can be selected from the group consisting of clay, silica gel, magnesium sulfate, calcium oxide, calcium chloride, molecular sieves (or zeolites) e.g., aluminosilicate, etc. and combinations thereof. Zeolites with defined port diameters can be preferred, in particular type 3A to type 10A molecular sieves.

Useful desiccants include those available under the INNOVOX trade designation from Birch Chemicals, including INNOVOX FG CAO, a microfine grade of calcium oxide powder.

The desiccant is present in the hot melt sealant at from 2% by weight, 3% by weight, 4% by weight, 5% by weight, 6% by weight to 14% by weight, 15% by weight, 16% by weight, 18% by weight, 20% by weight, or any two values there between.

### Silane Adhesion Promoter

The hot melt sealant can include a silane adhesion promoter. The silane adhesion promoter helps improve adhesion between the sealant and the glass. The silane adhesion promoter is not limited and can include any type of silane composition useful in promoting the adhesion of the hot melt sealant to a substrate.

The silane adhesion promoter can be selected from the group consisting of a silane, an amino silane, an epoxy silane, an isocyanurate silane and any other silane.

Useful silane adhesion promoters include those available under the DYNASYLAN trade designation, include DYNASYLAN GLYMO, a bifunctional organosilane possessing a reactive organic epoxide and hydrolyzable inorganic methoxysilyl groups, DYNASYLAN AMMO, 3-(trimethoxysilyl)propylamine and DYNASYLAN VPS7161, isocyanurate silane with a high concentration of trimethoxysilyl groups all available from Evonik GmBH (Hanau, Germany) and COATOSIL MP200, an epoxy functional silane oligomer available from Momentive Performance Materials Inc.

The hot melt sealant can include from 0.05% by weight to 5% by weight, from 0.1% to 3% by weight, from 0.1% by weight to 2% by weight, or even from 0.2% by weight to 1% by weight of the silane adhesion promoter.

### Dispersing Agent

The hot melt sealant can include a dispersing agent to help disperse the carbon black within the hot melt sealant.

The dispersing agent can be selected from the group consisting of liquid rubber, organometallics (e.g., titanates, zirconates, aluminates, etc.), acids (e.g., sulfonic acid, carboxylic acid, succinic acid, etc.), anhydrides (e.g., succinic anhydride), metal salts of organic acids, amines, surfactants, etc.

Useful dispersing agents include those available under the KALENE and ISOLENE trade designations from HB Fuller Company (Michigan) including KALENE 1300, ISOLENE 40-S and ISOLENE 400-S and those available under the LIR trade designation from Kuraray Co. Ltd. (Tokyo, Japan) including LIR 30, LIR 50 and LIR290.

The dispersing agent is in the hot melt sealant at from 0.2% by weight, 0.5% by weight, 1% by weight, to 4% by weight, 5% by weight, 6% by weight, 10% by weight or any two values there between.

### Additional Components

The hot melt sealant optionally includes other additives including, e.g., antioxidants, catalysts, UV-stabilizers (e.g., hindered amine light stabilizers), UV-absorbers, adhesion promoters, tackifying agent, additional polymers (styrene block copolymers, non modified olefin polymers, etc.) plasticizers (e.g., non-phthalate plasticizers), thermal stabilizers, optical brighteners, rheology modifiers, corrosion inhibitors, dehydrators, flame retardants, and combinations thereof.

Although it is preferred than the hot melt sealant be free of tackifying agent, the hot melt sealant can include limited amounts of tackifying agent. When present it is preferred that tackifying agent is present at less than 10% by weight, less than 5% by weight, or even less than 3% by weight.

The hot melt adhesive composition can include additional polymers. Useful additional polymers include styrene block copolymers. Useful styrene block copolymers include, e.g., triblock, multi-arm and radial copolymers including, e.g., styrene-butadiene-styrene (SBS), styrene-isoprene-styrene (SIS), styrene butadiene-isobutylene-styrene (SBBS), styrene-isoprene-butadiene-styrene (SIBS), styrene ethylene/butene-styrene (SEBS), styrene-ethylene/propylene-styrene (SEPS), styrene-ethylene ethylene/propylene-styrene (SEEPS), styrene-ethylene/butene/styrene-styrene (SEBSS) and combinations thereof. The styrene block copolymer can be selected from the group consisting of styrene butadiene-isobutylene-styrene (SBBS), styrene-isoprene-butadiene-styrene (SIBS), styrene ethylene/butene-styrene (SEBS), styrene-ethylene/propylene-styrene (SEPS), styrene-ethylene ethylene/propylene-styrene (SEEPS), styrene-ethylene/butene/styrene-styrene (SEBSS).

Hydrogenated styrene block copolymer can be preferred. The styrene block copolymer can have a styrene content of from 15% by weight to 30% by weight.

The hot melt sealant can include additional fillers. Useful additional fillers include, e.g., talc, fumed silica, precipitated silica, aluminum silicates, nano powders, calcium carbonate, and combinations thereof. Suitable fillers are commercially available under a variety of trade designations including, e.g., under the MISTRON series of trade designations from Imerys Talc America (Three Forks, Montana) including MISTRON VAPOR R microcrystalline talc.

Useful UV stabilizers include, e.g., UV stabilizers available under the TINUVIN series of trade designations including, e.g., TINUVIN 770 and TINUVIN 328. Useful antioxidants include e.g. antioxidants available under the IRGANOX series of trade designations including e.g., IRGANOX 1010 all of which are available from BASF Corporation (Florham, New Jersey). The UV stabilizer or antioxidant can be present in the composition in an amount of from 0% by weight to 3% by weight, from 0.1% by weight to 2% by weight, or even from 0.2% by weight to 1% by weight.

Catalyst can be added to the composition to increase the rate of crosslinking. Useful catalysts include, e.g., organotin compounds including, e.g., dialkyl tin dicarboxylates (e.g., dibutyl tin dilaurate and dibutyl tin diacetate, or dioctyl versions thereof), tin carboxylates, stannous salts of carboxylic acids (e.g., stannous octoate and stannous acetate), tetrabutyl dioleatodistannoxane, colorless organic titantates, organosilicon titantates, alkyltitantates, and metal alkoxides (e.g., aluminum isopropoxide and zirconium isopropoxide), and combinations thereof. The catalyst can be present in the composition in an amount of from 0% by weight to 2% by weight, 0.001% by weight to 2% by weight from 0.005% by weight to 1% by weight, or even from 0.01% by weight to 0.5% by weight.

### General Uses

The hot melt sealant is useful for bonding glass to various substrates including other glass substrates, polymer substrates, metallic substrates, and combinations thereof, and providing a moisture barrier function in a variety of applications and constructions. The hot melt sealant is particularly useful in constructions including, e.g., insulating glass units, solar modules (e.g., PV modules, and solar thermal modules), sash frame assemblies, automotive and molding applications, windows, doors, walls, and constructions that require good adhesion to glass, metal, plastic and combinations thereof.

### Insulating Glass Units

The hot melt sealant is particularly useful for bonding glass to various substrates including serving as a primary sealant, or even as a thermoplastic spacer between two glass panes in the formation of an insulating glass unit. The insulating glass unit can be selected from the group consisting of double pane insulating glass unit, multi pane insulating glass unit, and solar module.

The insulating glass unit can include a first pane of glass, a second pane of glass, and and the inventive hot melt sealant in contact with the first pane of glass and the second pane of glass.

The insulating glass unit can be used for windows (framed or unframed), conservatories, structural glazing, roof glazing, glazing in land, water, and air vehicles, and for solar modules. The insulating glass unit can be free of a mechanical spacer (e.g., metal or plastic), free of a secondary sealant, or free of both a mechanical spacer and a secondary sealant.

The hot melt sealant of this invention can be used in a method of making an insulating glass unit including two or more panes of glass. The method includes applying the hot melt sealant to the edge region of a first glass sheet by means of a suitable apparatus (e.g., extruder), aligning a second glass sheet in place over the top of the first glass sheet, and pressing the insulating glass unit to a predetermined thickness. In a second step, a secondary sealant can be applied to the joint formed between the glass panes and the hot melt sealant. The process can be repeated if additional panes are desired.

The insulating glass unit can also be filled with a gas selected from the group consisting of noble gases (e.g., argon, krypton, xenon, etc.), heavy gases (e.g., sulphur hexafluoride), and combinations thereof. The gases can help to improve various properties of the insulating glass unit including e.g., additionally lowering thermal conductivity or improving sound insulation properties.

### Solar Thermal Modules

In solar thermal modules the energy from sunlight is transformed into heat that can be used to support hydraulic heating systems or to make hot potable water.

Solar thermal modules are made in a similar way to insulating glass units. However, they are typically not gas filled and can have a somewhat different edge construction. The hot melt sealant can be used as a primary sealant or a single seal in a solar thermal module.

### Photovoltaic Module

Photovoltaic modules utilize photovoltaic technology to capture the energy from sunlight and directly convert it into electricity.

The hot melt sealant can be used as an edge seal on a photovoltaic module. A photovoltaic module can include from top (sun facing side) to bottom: a front sheet, an encapsulant, a layer of photovoltaic cells in contact with the back sheet, and a back sheet. Alternatively, a photovoltaic module can include from top (sun facing side) to bottom: a front sheet, an encapsulant, a layer of photovoltaic cells, an encapsulant, and a back sheet. The front sheet can be glass. The back sheet can be selected from the group consisting of glass and polymer film.

The edge seal is a material that forms a seal between the outer edges of the front sheet and back sheet to provide an extra barrier to prevent moisture from weakening the structure of the module or damaging the cells. The hot melt sealant of this invention can serve as this edge seal.

### Methods of Application

The hot melt sealants of this invention can be applied in any suitable manner.

The hot melt sealants can be applied by extrusion. When used as a thermoplastic spacer, application equipment from Glaston Corporation (Helsinki, Finland), Lisec Company GmbH (Austria), and Forel SPA (Italy) can be useful.

The invention will now be described by way of the following examples.

### Examples

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified. The sealant compositions were prepared by mixing the materials together in a sigma blade mixer at a temperature of between 120° C. and 160° C.

Heat Conductivity was testing according to ASTM D5470 with TIM-Tester from ZFW (Stuttgart, Germany).

Density was tested according to EN ISO 2811-1.

Melt Volume Flow Rate (MVR) was tested according to EN ISO 1133 under the following conditions: 10 kg, 130° C., 2.16 mm nozzle.

Penetration was tested according to ASTM D 1321.

### Glass Wet Out Speed

The materials to be tested were stored in an aluminum cartridge at 160° C. for at least 2 hours (either in the hotmelt gun or in the heating oven). The sealant was also applied at 160° C. in a hotmelt gun (using an appropriate pressure or up to 6 bars).

From the pre-tempered aluminum cartridge, a sealant bead is applied to a glass test specimen measuring 50 mm×50 mm×5 mm with the help of a hotmelt gun and immediately pressed to a layer thickness of 4 mm with a second glass test specimen of the same dimension (4 mm spacers are placed between both glass test specimens before pressing). The material is considered completely wet out the glass surface when there are no more “gray” spots i.e. when the sealant has completely wetted out the second substrate.

The evaluation of the result is done optically and can obtain the ratings ++, +, o, − and −: ++ Wet Out complete within <15 min
+ Wet Out completely within 1 h
o Wet Out complete within 4 h
− Wet Out completely within 24 h
−− no complete Wet Out after 24 h

TABLE 1

| | Control 1 | EX. 1 | EX. 2 | EX. 3 |
|---|---|---|---|---|
| VESTOPLAST 206 | | 11.3 | 4.5 | 8.4 |
| LMW POLYBUTENE | | 0 | 3.3 | 4.3 |
| COMPONENT | | | | |
| MMW POLYBUTENE | | 40.65 | 45.3 | 40.7 |
| COMPONENT | | | | |
| HMW POLYBUTENE | | 6.8 | 5.5 | 5.4 |
| COMPONENT | | | | |
| DISPERSING AGENT | | 2.3 | 2.3 | 2.4 |
| CAO | | 11.3 | 11.3 | 12.0 |
| CARBON BLACK | | 27.1 | 27.3 | 26.3 |
| SILANE ADHESION | | 0.50 | 0.45 | 0.45 |
| PROMOTER | | | | |
| IRGANOX 1010 | | .05 | .05 | .05 |
| Total Polymer Component | 50.5 | 61.6 | 61.4 | 61.7 |
| Total Non-Desiccant Filler | 37.9 | 27.1 | 27.3 | 26.3 |
| Heat Conductivity | .347 | .306 | .311 | .312 |
| (Watts/m-K) | | | | |
| Density (g/cm³) | 1.27 | 1.15 | 1.16 | 1.15 |
| MVR (cm³/10 min) | 14.9 | 10.5 | 12.7 | 15.0 |
| Penetration ASTM D 1321 | 16 | 17 | 16 | 20 |
| (1/10 mm) | | | | |
| Glass Wet Out Speed | O | ++ | ++ | ++ |

Control 1 is a prior art hot melt sealant.

1. A hot melt sealant comprising:
a. from 1% by weight to 30% by weight of a silane modified polymer,
b. from 30% by weight to 65% by weight of a butene component,
c. from 10% by weight to 34% by weight of carbon black,
d. from 2% by weight to 20% by weight of a desiccant,
wherein the hot melt sealant has a total polymer content of greater than 55% by weight.

2. The hot melt sealant of claim 1 wherein the total of a., b., c., and d. makes up at least 80% by weight of the hot melt sealant.

3. The hot melt sealant of claim 1 comprising a total polymer content of greater than 58% by weight.

4. The hot melt sealant of claim 1 having a density of no greater than 1.18 g/cm³ when tested according to EN ISO 2811-1.

5. The hot melt sealant of claim 1 having a thermal conductivity of no greater than 0.330 Watts/m-K when tested according to ASTM D5470.

6. The hot melt sealant of claim 1 comprising from 22% by weight to 32% by weight of the carbon black.

7. The hot melt sealant of claim 1 wherein the carbon black makes up at least 70% by weight of the non-desiccant filler in the hot melt sealant.

8. The hot melt sealant of claim 1 wherein the carbon black makes up at least 90% by weight of the non-desiccant filler in the hot melt sealant.

9. The hot melt sealant of claim 1 wherein the butene component is selected from the group consisting of polybutene, polyisobutene, polyisobutylene, butyl rubber and combination thereof.

10. The hot melt sealant of claim 1 wherein the butene component comprises a medium molecular weight (Mₙ) butene component and a high molecular weight (Mₙ) butene component.

11. The hot melt sealant of claim 1 wherein the butene component includes at least two different butene components having different molecular weights (Mₙ).

12. The hot melt sealant of claim 1 further comprising a silane adhesion promoter.

13. The hot melt sealant of claim 1 wherein the silane modified polymer is a silane modified olefin having a silicon content as tested by KAA 04-3080 of from 0.2% to 5% by weight.

14. The hot melt sealant of claim 1 wherein the silane modified polymer is a silane modified olefin selected from the group consisting of a silane modified amorphous poly alpha olefin, a silane modified single-site catalyzed olefin, and combinations thereof.

15. The hot melt sealant of claim 1 further comprising a dispersing agent.

16. A hot melt sealant comprising:
a. from 2% by weight to 18% by weight of a silane modified polymer,
b. from 35% by weight to 60% by weight of a butene component,
c. from 15% by weight to 32% by weight of carbon black,
d. from 3% by weight to 18% of a desiccant, wherein the hot melt sealant has a total polymer content of greater than 55% by weight and the carbon black makes up at least 70% by weight of the non-desiccant filler in the hot melt sealant.

17. An article selected from the group consisting of insulating glass unit, photovoltaic module and solar thermal module comprising the hot melt sealant of claim 1.

18. An insulating glass unit comprising:
a. a first pane of glass,
b. a second pane of glass, and
and the hot melt sealant of claim 1 in contact with the first pane of glass and the second pane of glass.

19. The insulating glass unit of claim 18 being free of a mechanical spacer.

20. The insulating glass unit of claim 19 being free of a secondary sealant.
